(19) United States
(12) Patent Application Publication
(10) Pub. No.: US 2022/0402568 A1
(43) Pub. Date: Dec. 22, 2022

(54) BICYCLE LOCKING DEVICE

(71) Applicants: Joshua Squire, Miami Beach, FL (US); John Romero, Phoenix, AZ (US); Darin Graf, Mesa, AZ (US)

(72) Inventors: Joshua Squire, Miami Beach, FL (US); John Romero, Phoenix, AZ (US); Darin Graf, Mesa, AZ (US)

(21) Appl. No.: 17/807,560

(22) Filed: Jun. 17, 2022

Related U.S. Application Data
(60) Provisional application No. 63/202,589, filed on Jun. 17, 2021.

(51) Int. Cl. B62H 5/00; B62H 5/14

(52) U.S. Cl. CPC B62H 5/003; B62H 5/145

(57) ABSTRACT

A smart bicycle locking device having a body portion with an operatively associated cable and pin locking mechanism. The cable and pin locking mechanism provides a cable extending from a proximal end to a distal end, wherein the proximal end is pivotable connected to the body portion, and wherein the distal end connects to a locking pin. The body portion provides first and second locking engagement receptacles oriented transverse relative to each other. Each locking engagement receptacle may slidably receive the locking pin, wherein the second locking engagement receptacle is configured to automatically lock the locking pin in a locked position. The pivotable connection facilitates the horseshoe cable being movable between a vertical and a lateral orientation. The locking pin can only be removed from the second locking engagement receptacle via an authorized signal provided to an authorized user.

### CROSS-REFERENCE TO RELATED APPLICATION

This application claims the benefit of priority of U.S. provisional application No. 63/202,589, filed 17 Jun. 2021, the contents of which are herein incorporated by reference.

### BACKGROUND OF THE INVENTION

The present invention relates to bicycle locks and, more particularly, a smart bicycle locking device having a body portion with an operatively associated cable and pin locking mechanism, wherein the body portion has two locking engagement receptacles oriented generally orthogonal relative to each other, wherein each locking engagement receptacle receives a locking pin of the cable and pin mechanism in an unlocked position and an automatically locked position, respectively.

Bicycle-sharing systems make bikes available for shared use on a short-term basis for a price or even for free. Many bike share systems allow people to borrow a bike from a “dock” and return it at another dock belonging to the same system, wherein the dock has special bike racks that locks the bike. However, for dock-less shared bikes there is a need for a shared-bike locking device for securing the shared bicycle and locking it to a standard bicycle rack or another fixed, stationary object, yet still allow other individuals authorized by the bicycle-sharing system to unlock the bike when appropriately enabled.

Moreover, other locking devices only lock the bike wheel, but do not secure the bike frame to a bike rack or fixed object with a cable that is part of the lock; thus, current bike locks offer a suboptimal locking configuration, as the wheel can be separated from the more expensive frame and the bike frame easily stolen. Current cable-based locks also do not have a good way to store the lose cable when riding.

As can be seen, there is a need for a smart bicycle locking device having a body portion with an operatively associated cable and pin locking mechanism. The cable and pin locking mechanism provides a cable extending from a proximal end to a distal end, wherein the proximal end is pivotable connected to the body portion, and wherein the distal end provide/connects to a locking pin. The body portion provides a first and a second locking engagement receptacle oriented generally orthogonal relative to each other. Each locking engagement receptacle may slidably receive the locking pin, wherein the first locking engagement receptacle receives the locking pin in an unlocked position, and wherein the second locking engagement receptacle automatically engages the locking pin in a locked position.

By manipulating the cable so that its proximal end pivots about the body portion, a user may move the locking pin between the locked and unlocked position. In certain embodiments, upon reception within the second locking engagement receptacle the locking pin is automatically in the locked position by way of a smart lock (housed in the body portion); as such, the locking pin can only be removed from the second locking engagement receptacle via an authorized signal. The authorized signal may be generated by smart device by way of a software application loaded thereon, a near field communication (NFC) card, or other electronic system that enables electrical communication with the smart lock to switch to an unlocked condition, thereby unlocking for the locking pin received in the second locking engagement receptacle. The smart bicycle locking device may be attachable to a bicycle frame so that the cable and pin mechanism can lock the bike to a fixed object, like a public bike rack or bike station. Accordingly, the present invention is ideal for bicycle rental and sharing systems.

The first locking engagement receptacle may act as a holster sheathing the locking pin, thereby providing a good way to store the cable portion when riding. In this holstered position the cable portion of the cable and pin configuration may be vertically oriented so that it is generally within the vertical profile of the bicycle frame.

### SUMMARY OF THE INVENTION

In one aspect of the present invention, a bicycle locking device includes the following: a body portion having: a first engagement point; and a second engagement point, wherein the first and second engagement points approximately orthogonally oriented relative to each other; a cable having a proximal end pivotable connected to the body portion; and a distal end of the cable mechanically communicating with a locking pin, wherein locking pin is dimensioned to separately engage each engagement point, and wherein the second engagement point is configured to automatically form a locked engagement with the engaged locking pin.

In another aspect of the present invention, the above-mentioned bicycle locking device, further including an electronic lock operatively associated with the second engagement point, wherein the smart lock forms the locked engagement, and wherein the smart lock is configured to move the locking pin to an unlocked engagement upon receiving an authorized signal; a pivotable connection point operatively associated with said proximal end, wherein the pivotable connection point is spaced apart from both engagement points so that each separate engagement thereof by the locking pin forms a horseshoe shape of the cable, wherein the cable is flexible so as to form a linear shape from the horseshoe shape when the locking pin is not engaged with either engagement point, wherein the pivotable connection point is constrained from pivoting more than approximately ninety degrees, wherein the second engagement point is a receptacle, and wherein the locking pin is dimensioned so that at least four inches of a distal end of the locking pin extends out of the receptacle, wherein the second engagement point is a receptacle that communicates to opposing sides of the body portion, and wherein the locking pin is dimensioned so that at least four inches of a distal end of the locking pin extends out of the receptacle on an opposing side from a reception side, wherein the first and second engagement points are disposed along the body portion in such a way that engagement by the locking pin of the first engagement point defines a vertical orientation of the horseshoe shape, and wherein engagement by the locking pin of the second engagement point defines a lateral orientation of the horseshoe shape, wherein the body portion provides a casing having a top surface, a bottom surface opposite the top surface, and a sidewall peripherally interconnecting the top and bottom surfaces, wherein the first engagement point is a receptacle formed in the top surface, wherein the second engagement point is a receptacle that communicates opposing sides of the sidewall, wherein the bottom surface provides fastening elements for connecting to a bicycle, wherein the casing constrains the pivotable connection point to approximately ninety degrees of rotation about an axis extending between the pivotable connection point and the first engagement point, wherein the locking pin is dimensioned so that at least four inches of a distal end of the locking pin extends out of the second engagement point on the opposing side that is was received, wherein the distal end of the locking pin received in the second engagement point extends through a spoke region of the bicycle the bottom surface is fastened thereto, and wherein the pivotable connection point is in a first orientation when the locking pin is engaged with the first engagement point, and wherein the pivotable connection point is in a second orientation when the locking pin is engaged with the second engagement point, wherein the first orientation defines a vertical orientation of the horseshoe shape, and wherein the second orientation defines a lateral orientation of the horseshoe shape, and wherein the first and second orientations are oriented approximately ninety degrees relative to each other.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use, illustrating a locked position.

FIG. 2 is a top plan view of an exemplary embodiment of the present invention, illustrating a locked position.

FIG. 3 is a top perspective view of an exemplary embodiment of the present invention, illustrating the locked position in the second locking engagement receptacle.

FIG. 4 is a perspective view of an exemplary embodiment of the present invention, illustrating a locked position.

FIG. 5 is a perspective view of an exemplary embodiment of the present invention, with the casing removed for clarity, illustrating a locked position.

FIG. 6 is a perspective view of an exemplary embodiment of the present invention, with the pivotable connection point and the cable removed for clarity.

FIG. 7 is a perspective view of an exemplary embodiment of the present invention, shown in use, illustrating an unlocked position.

FIG. 8 is a perspective view of an exemplary embodiment of the present invention, shown in use, illustrating a locked position.

FIG. 9 is a bottom perspective view of an exemplary embodiment of the present invention, illustrating an unlocked position.

FIG. 10 is a top perspective view of an exemplary embodiment of the present invention, illustrating an unlocked position, with the cable in a first orientation (upward relative to the body portion).

FIG. 11 is a top perspective view of an exemplary embodiment of the present invention, illustrating a locked position, with the cable in a second orientation (sideways/lateral relative to the body portion).

FIG. 12 is a perspective view of an exemplary embodiment of the present invention, shown in use.

FIG. 13 is a perspective view of an exemplary embodiment of the present invention, shown in use

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a smart bicycle locking device having a body portion with an operatively associated cable and pin locking configuration. The cable and pin locking configuration provides a cable extending from a proximal end to a distal end, wherein the proximal end is pivotable connected to the body portion, and wherein the distal end connects to a locking pin. The body portion provides a first and a second locking engagement receptacle oriented orthogonal relative to each other. Each locking engagement receptacle may slidably receive the locking pin, wherein the first locking engagement receptacle receives the locking pin in an unlocked position, and wherein the second locking engagement receptacle automatically locks the locking pin in a locked position. By manipulating the cable so that its proximal end pivots about the body portion, a user may move the locking pin between the locked and unlocked positions. In certain embodiments, upon reception with the second locking engagement receptacle, the locking pin is automatically in the locked position by way of a smart lock of the body portion; as such, the locking pin can only be removed from the second locking engagement receptacle via an authorized signal. The authorized signal may be generated by smart device by way of a software application loaded thereon, a near field communication (NFC) card, or other electronic system that enables electrical communication with the smart lock to switch to an unlocked position for the locking pin received in the second locking engagement receptacle.

The smart bicycle locking device is attachable to a bicycle frame in a fixed manner so that the cable of the cable and pin mechanism may lock the bike to an object, like a public bike rack or bike station. Accordingly, the present invention is ideal for bicycle rental and sharing systems.

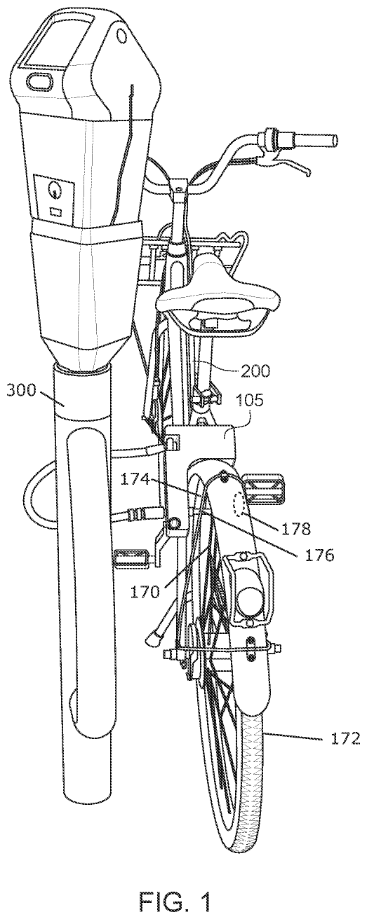

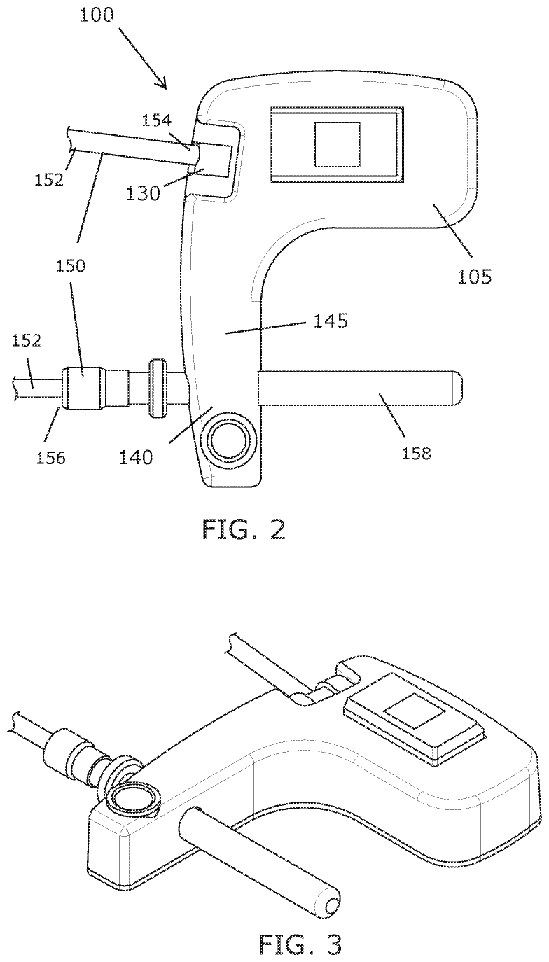

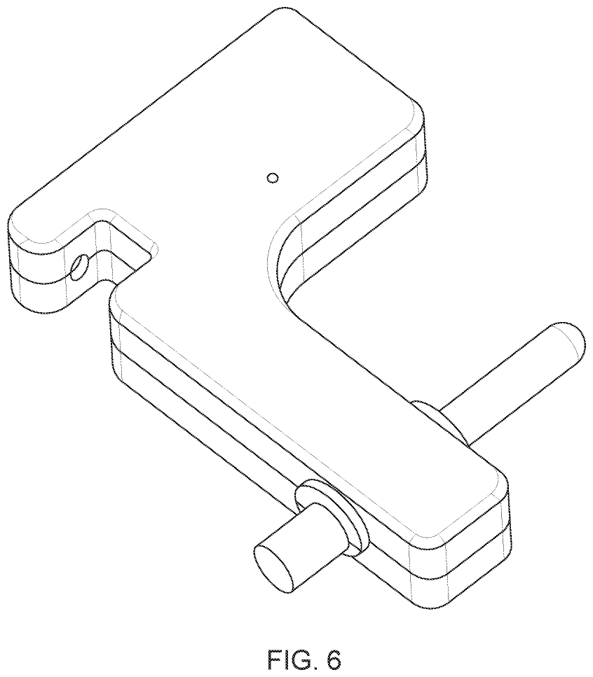

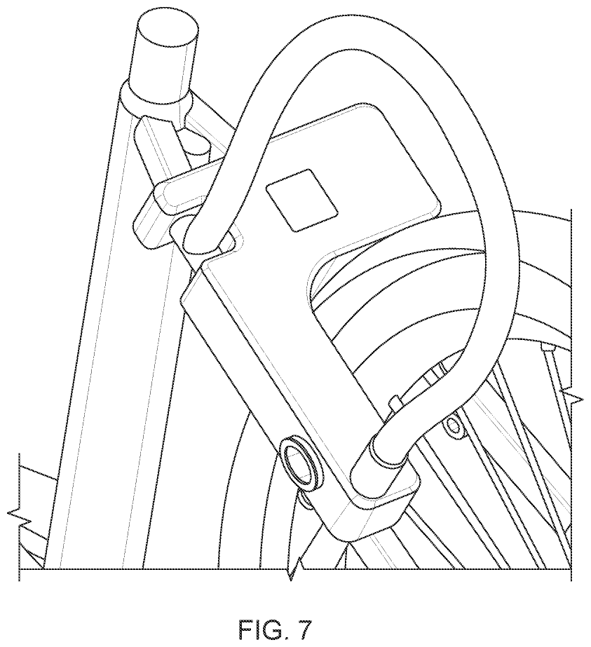

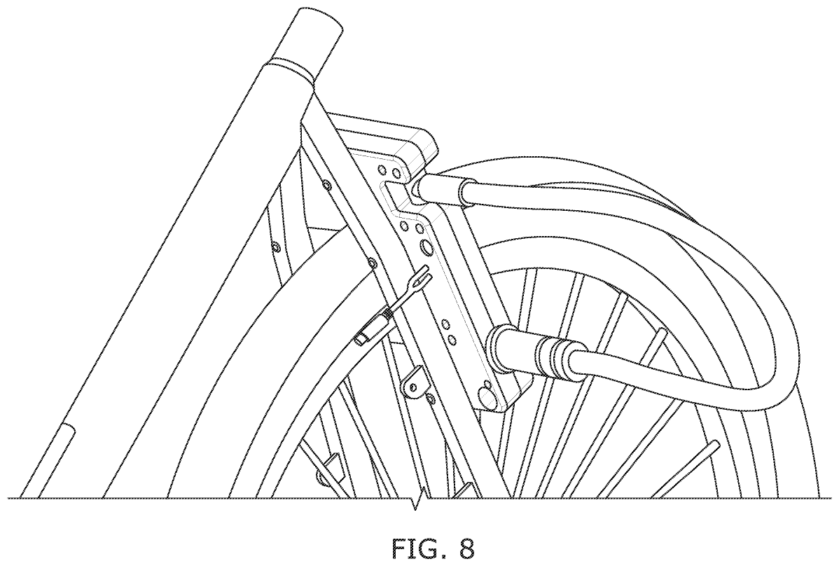

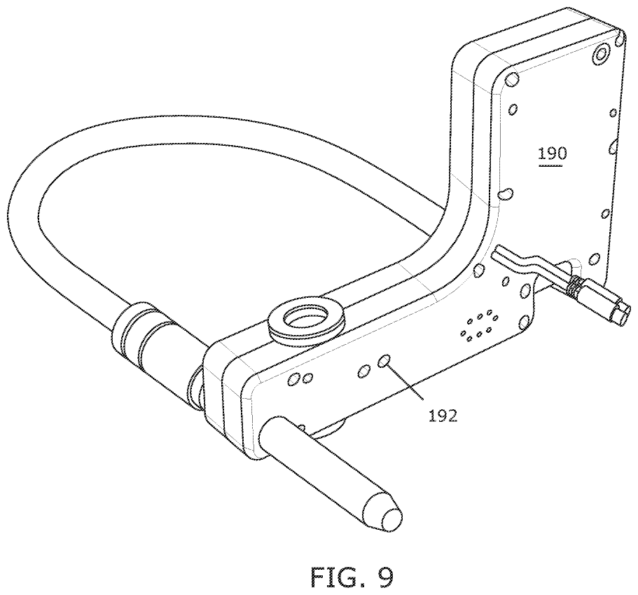

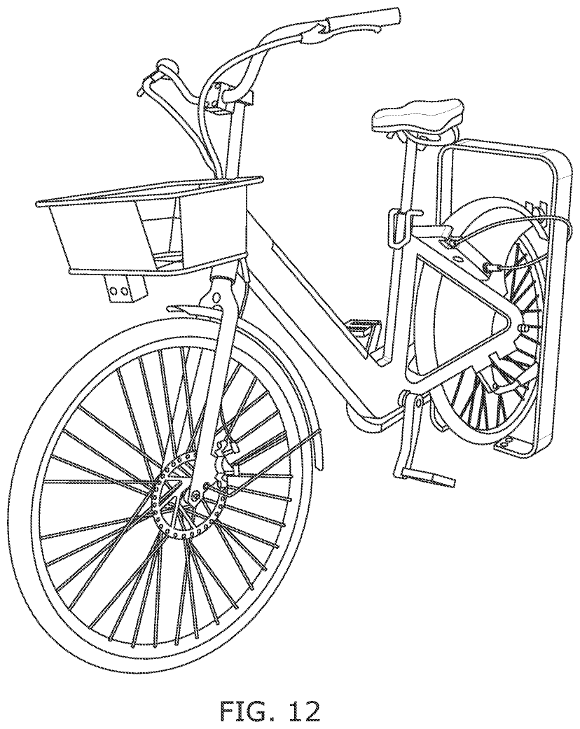

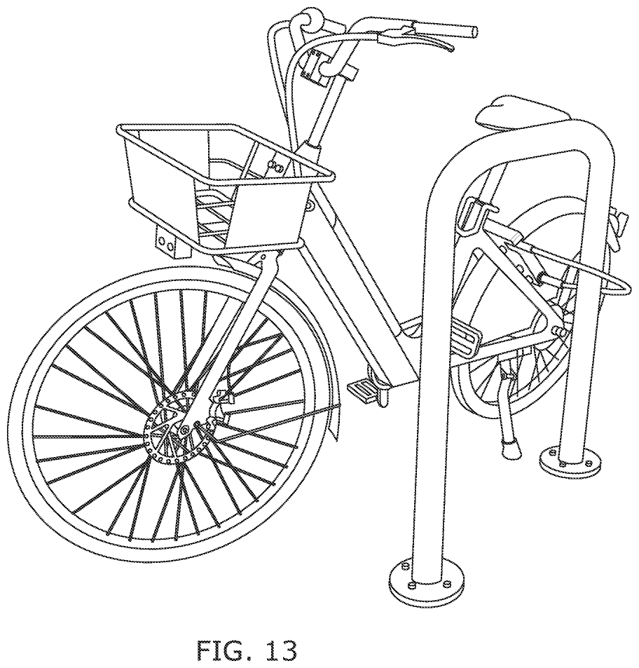

Referring now to FIGS. 1 through 13, the present invention may include a smart bicycle locking device 100. The smart bicycle locking device 100 may include a body portion 105. The body portion 105 may provide a pivotable connection point 130. The body portion 105 may provide a locking engagement area 140 spaced apart from the pivotable connection point 130 by at least three inches. The locking engagement area 140 may be located along an elongated portion 145 of the body portion 105. The locking engagement area 140 may provide a first locking engagement receptacle 141 and a second locking engagement receptacle 142. The first locking engagement receptacle 141 and the second locking engagement receptacle 142 are oriented approximately orthogonally or transverse relative to each other.

The smart bicycle locking device 100 may be operatively associated with a cable and pin locking mechanism 150. The cable and pin locking mechanism 150 may provide a cable 152 extending from a proximal end 154 to a distal end 156, wherein the proximal end 154 is pivotable connected to the pivotable connection point 130, and wherein the distal end 156 is in mechanical communication with a locking pin 158.

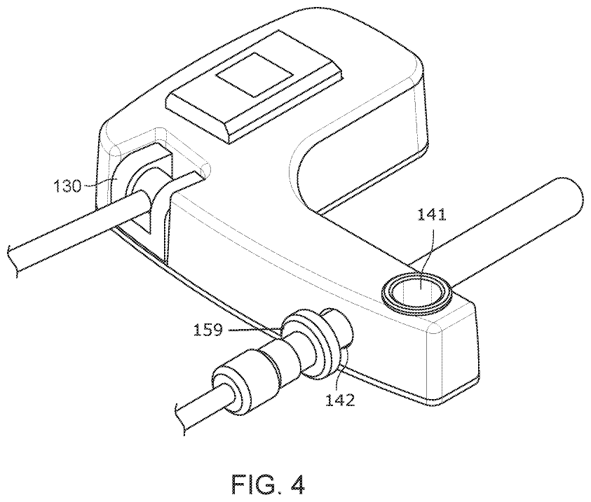

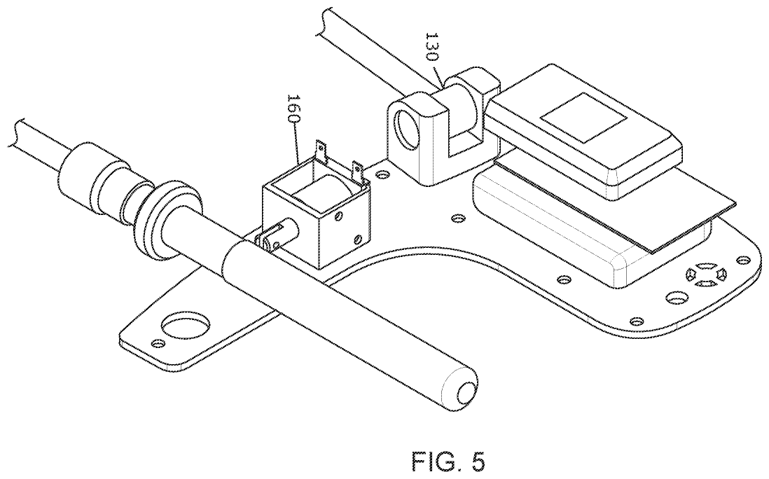

The first locking engagement receptacle 141 and the second locking engagement receptacle 142 are each dimensioned and adapted to slidably receive the locking pin 158. In this received position, the locking pin 158 slides through and out the opposing side of the body portion 105. Accordingly, when the locking pin 158 is received through the second locking engagement receptacle 142, a distal end of the locking pin 158 protrudes from the other side of the elongated portion by at least four inches, as illustrated in FIG. 4.

The body portion 105 provides a smart lock 160 configured to automatically lock the locking pin 158 received sufficiently within the second locking engagement receptacle 142. The ‘sufficiency of reception’ may range from confirmation of the locking pin 158 within any part of the second locking engagement receptacle 142 to when the locking pin 158 is through the second locking engagement receptacle 142 to its hilt 159, or somewhere in between. The smart lock 160 is moveable between an unlocked condition and a locked condition, and in the locked condition the locking pin 158 is considered in the locked position. Accordingly, the locking pin 158 is automatically in the locked position when sufficiently placed within the second locking engagement receptacle 142 by way of the smart lock 160.

An authorized user may have a signal generator (not shown) that communicates with the smart lock 160 to move it from a locked condition to an unlocked condition. In certain embodiments, this is the only way the user can remove the locking pin 158 from the second locking engagement receptacle 142. The signal generator may be smart device loaded with a systemic software, a NFC card, or other electronic device capable for communicating with the smart lock 160 and moving it between the locked condition and the unlocked condition. The smart bicycle locking device 100 may be configured to only release by computer control, thereby enabling bicycle-sharing system use. For example, the user enters payment information, and an application on their mobile computer can unlock the bike for use for a predetermine amount of time.

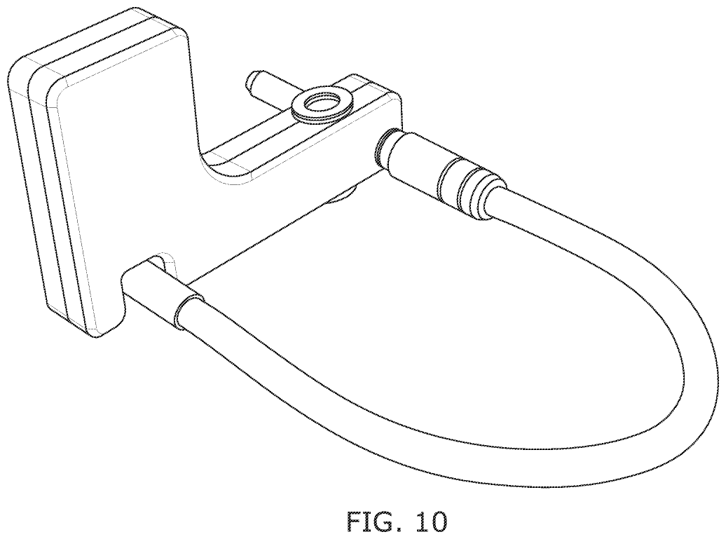

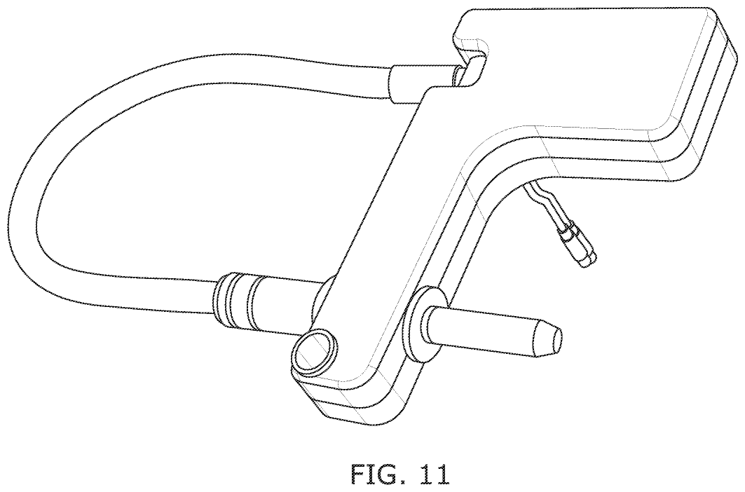

The user of the present invention can thus move the cable and pin mechanism 150 between the unlocked position (sheathed in or unsheathed from the first locking engagement 141) and the locked position by sliding the locking pin 158 into the second locking engagement 142. The pivotable connection point 130 enables the cable 150 to swivel between a first orientation directed upward, relative the body portion 105 (from the pivotable connection point 130) as illustrated in FIG. 10, to a second orientation directed sideways relative to the body portion 105, as illustrated in FIG. 11.

The body portion 105 may be fixed to a bicycle frame 200 so that an upper surface of the body portion 105 is facing upward relative to a supporting surface of the bicycle. In the first orientation so that the cable 152 generally does not protrude beyond a profile of the bicycle frame 200. Thereby, with the cable 152 in the vertically oriented first orientation the cable and pin mechanism 150 defines a convenient storage position when riding the bike. When the bike is parked, the user can move the locking pin 158 to the second locking engagement receptacle 142 and the locked position. In the process of forming the locking position the cable 152 may be pivoted to the second orientation, thus extending laterally so that its horseshoe shape lassos a rack/object 300.

Attachment holes 192 along a bottom surface 190 of the casing may facilitate the fixed attachment of the body portion 105 to the bike frame 200. The horseshoe design/shape of the cable 152 enables the smart bicycle locking device 100 to attach the body portion 105 to the bicycle frame 200 in a unique way and so that the operatively associated cable 152 is laterally oriented in the locked position and vertically oriented in the ‘safe storage’, unlocked position.

In the lateral locked position, the locking pin 158 may extend sufficiently beyond the elongated portion 145 so that the distal end of the locking pin 158 passes through the spokes 170 of the bike's wheel 172. In other embodiments, the wheel 172 may have a skirt guard 174 with aligned opposing holes 176 that the locking pin 158 slides through. One of those opposing holes 176 may be an eyelet 178 that is connected to the skirt guard 174 or the frame 200 of the bicycle.

A method of manufacturing the present invention may include the following. A manufacture may first design the casing of the body portion 105 so it can hold all the electronics, IOT, and smart lock 160, and securely be attached to the bicycle. The cable and pin mechanism 150 operatively associates with the body portion 105, allowing the former's movement between the locked and unlocked positions. When the locking pin 158 is inserted through the second locking engagement receptacle it must stop at one point and lock. When the cable is unlocked it may be stored in a vertical orientation that does not interfere with the operation of the bicycle/wheels 172.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A bicycle locking device, comprising:
a body portion comprising:
a first engagement point; and
a second engagement point, wherein the first and second engagement points approximately orthogonally oriented relative to each other;
a cable having a proximal end pivotable connected to the body portion; and
a distal end of the cable mechanically communicating with a locking pin, wherein locking pin is dimensioned to separately engage each engagement point, and wherein the second engagement point is configured to automatically form a locked engagement with the engaged locking pin.

2. The bicycle locking device of claim 1, further comprising an electronic lock operatively associated with the second engagement point, wherein the smart lock forms the locked engagement, and wherein the smart lock is configured to move the locking pin to an unlocked engagement upon receiving an authorized signal.

3. The bicycle locking device of claim 1, further comprising a pivotable connection point operatively associated with said proximal end, wherein the pivotable connection point is spaced apart from both engagement points so that each separate engagement thereof by the locking pin forms a horseshoe shape of the cable.

4. The bicycle locking device of claim 3, wherein the cable is flexible so as to form a linear shape from the horseshoe shape when the locking pin is not engaged with either engagement point.

5. The bicycle locking device of claim 3, wherein the pivotable connection point is constrained from pivoting more than approximately ninety degrees.

6. The bicycle locking device of claim 1, wherein the second engagement point is a receptacle, and wherein the locking pin is dimensioned so that at least four inches of a distal end of the locking pin extends out of the receptacle.

7. The bicycle locking device of claim 1, wherein the second engagement point is a receptacle that communicates to opposing sides of the body portion, and wherein the locking pin is dimensioned so that at least four inches of a distal end of the locking pin extends out of the receptacle on an opposing side from a reception side.

8. The bicycle locking device of claim 5, wherein the first and second engagement points are disposed along the body portion in such a way that engagement by the locking pin of the first engagement point defines a vertical orientation of the horseshoe shape, and wherein engagement by the locking pin of the second engagement point defines a lateral orientation of the horseshoe shape.

9. The bicycle locking device of claim 8, wherein the body portion provides a casing having a top surface, a bottom surface opposite the top surface, and a sidewall peripherally interconnecting the top and bottom surfaces, wherein the first engagement point is a receptacle formed in the top surface, wherein the second engagement point is a receptacle that communicates opposing sides of the sidewall, wherein the bottom surface provides fastening elements for connecting to a bicycle.

10. The bicycle locking device of claim 9, wherein the casing constrains the pivotable connection point to approximately ninety degrees of rotation about an axis extending between the pivotable connection point and the first engagement point.

11. The bicycle locking device of claim 9, wherein the locking pin is dimensioned so that at least four inches of a distal end of the locking pin extends out of the second engagement point on the opposing side that is was received.

12. The bicycle locking device of claim 11, wherein the distal end of the locking pin received in the second engagement point extends through a spoke region of the bicycle the bottom surface is fastened thereto.

13. The bicycle locking device of claim 10, wherein the pivotable connection point is in a first orientation when the locking pin is engaged with the first engagement point, and wherein the pivotable connection point is in a second orientation when the locking pin is engaged with the second engagement point, wherein the first orientation defines a vertical orientation of the horseshoe shape, and wherein the second orientation defines a lateral orientation of the horseshoe shape, and wherein the first and second orientations are oriented approximately ninety degrees relative to each other.
